(19) United States
(12) Patent Application Publication
(10) Pub. No.: US 2026/0341593 A1
(43) Pub. Date: Oct. 29, 2026

(54) PROCESS AND DEVICE FOR MANUFACTURING A MAGNETIC BODY WITH SINUSOIDAL MAGNETISATION OF HALBACH TYPE

(71) Applicant: SAFRAN, PARIS (FR)

(72) Inventors: Alexandre FLEURY, MOISSY-CRAMAYEL (FR); Christophe VIGUIER, MOISSY-CRAMAYEL (FR); Pierre SALLOT, MOISSY-CRAMAYEL (FR)

(21) Appl. No.: 19/486,403

(22) PCT Filed: May 21, 2024
(86) PCT No.: PCT/EP2024/063888

§ 371 Date: Nov. 21, 2025

(30) Foreign Application Priority Data
May 24, 2023 (FR) FR2305127

(51) Int. Cl. H01F 41/02; H01F 1/057; H01F 1/08; H01F 13/00

(52) U.S. Cl. CPC H01F 41/0273; H01F 1/083; H01F 1/086; H01F 13/003; H01F 41/0266; H01F 1/0578

(57) ABSTRACT

A process for manufacturing a magnetic body with sinusoidal magnetisation of Halbach type includes introducing into a shaper, of linear or annular shape, a mixture including magnetic particles and at least one binder; heating the mixture to a heating temperature between the glass-transition temperature of the binder and the Curie temperature of the magnetic particles; aligning the magnetic particles so as to assign them a magnetisation vector that extends in a magnetisation plane and the direction of which varies continuously; and cooling the mixture down to a cooling temperature below the glass-transition temperature of the binder.

The present invention relates to the manufacture of magnetic parts, and more precisely, those with a sinusoidal magnetisation of Halbach type.

### BACKGROUND OF THE INVENTION

In manner known per se, a Halbach array is a particular arrangement of permanent magnets that increases the magnetic field on one side of the array while almost completely cancelling the magnetic field on the other side of said array.

FIG. 1 and FIG. 2 respectively show a first Halbach array R₁ of linear shape and a second Halbach array R₂ of annular shape. Each of the first and second arrays R₁, R₂, in this case, comprises first magnets A_{1.1}, A_{1.2} which have substantially collinear first magnetisation vectors V_{1.1}, V_{1.2} and which are separated in pairs by second magnets A_{2.1}, A_{2.2} having second magnetisation vectors V_{2.1}, V_{2.2} substantially perpendicular to the first magnetisation vectors V_{1.1}, V_{1.2} of the first magnets A_{1.1}, A_{1.2}.

It is known to use such magnetic structures for different applications, for example, magnetic bearings, magnetic refrigeration equipment, magnetic resonance equipment, permanent magnet motors, etc.

One process for manufacturing such magnetic structures consists of using an adhesive to bond the first magnets A_{1.1}, A_{1.2} and the second magnets A_{2.1}, A_{2.2} together. The mutual repulsion between the first magnets A_{1.1}, A_{1.2} and the second magnets A_{2.1}, A_{2.2} makes them difficult to position and requires a mould or specific tooling to hold them in position and clamp them during bonding, such that such a manufacturing process is not adapted for mass production.

Moreover, the juxtaposition of magnets generates a sudden variation in the magnetic orientation from one magnet to another.

Another process consists of manufacturing a single magnet by using a mould and orientating it magnetically by using a complex and expensive magnetisation device, comprising a large number of coils. Such a process is thus applicable only to a given geometry and size of structure, and the power of the magnetic field generated by the structure proves to be limited.

### AIM OF THE INVENTION

The invention thus aims to propose a simple and inexpensive process for manufacturing a magnetic body with sinusoidal magnetisation of Halbach type emitting a magnetic field whose direction varies continuously in a magnetisation plane of the body.

### SUMMARY OF THE INVENTION

To this end, the invention provides a process for manufacturing a magnetic body with sinusoidal magnetisation of Halbach type, the process comprising the following steps:
introducing into a shaper, of linear or annular shape, a mixture comprising magnetic particles and at least one binder;
heating the mixture to a heating temperature between the glass-transition temperature of the binder and the Curie temperature of the magnetic particles;
when the shaper is of linear shape, aligning the magnetic particles so as to assign them a magnetisation vector that extends in a magnetisation plane containing a longitudinal axis of the shaper and whose direction varies continuously as a function of the distance separating the magnetic particles and one end of the shaper;
when the shaper is of annular shape, aligning the magnetic particles so as to assign them a magnetisation vector that extends in a magnetisation plane orthogonal to a central axis of the shaper and whose direction varies continuously as a function of the angular position of the magnetic particles about the central axis;
cooling the mixture down to a cooling temperature below the glass-transition temperature of the binder.

In addition to being adapted for mass production, such a process makes it possible to generate a continuous variation in the magnetic orientation of the body.

According to a particular feature, the process further comprises de-binding and sintering the mixture.

In a particular manner, the process further comprises reinforcing the magnetic field emitted by the magnetic particles.

The invention also relates to a magnetic alignment device for implementing such a process. The device comprises:
a motorised platform arranged to ensure, when the shaper is of linear shape, a translation of said shaper along its longitudinal axis, or, when the shaper is of annular shape, a rotation of said shaper about its central axis;
a heating element attached relative to the motorised platform and arranged to locally increase the temperature of the mixture contained in the shaper up to the heating temperature;
a cooling element attached relative to the motorised platform and arranged to locally decrease the temperature of the mixture contained in the shaper up to the cooling temperature; and
a one-directional flux generator arranged between the heating element and the cooling element, and arranged to locally subject the magnetic particles to a one-directional magnetic flux that extends in the magnetisation plane and whose direction varies continuously as a function of the displacement or rotation of the shaper.

In a particular manner, the heating element comprises a heating collar arranged to extend around a portion of the shaper.

In a particular manner, the heating collar is of the resistive type.

In a particular manner, the cooling element comprises a cooling collar arranged to extend around a portion of the shaper.

In a particular manner, the cooling collar is a copper ring cooled by circulating water or by spraying a decompression gas.

In a particular manner, the one-directional magnetic flux generator comprises at least one electromagnetic coil that is selectively powered by an electric current to generate a magnetic field from which the one-directional magnetic flux is obtained.

In a particular manner, the one-directional magnetic flux generator comprises a first electromagnetic coil and a second electromagnetic coil arranged perpendicularly to each other, the first coil and the second coil being, respectively, powered by a first electric current and a second electric current arranged to generate a first magnetic field and a second magnetic field from which the one-directional magnetic flux is obtained, and to vary the direction of said one-directional magnetic flux in the magnetisation plane.

### BRIEF DESCRIPTION OF THE DRAWINGS

The invention will be best understood in the light of the description below, that is purely illustrative and non-limiting, and must be read regarding the accompanying drawings, among which:

FIG. 1 is a diagrammatic view of a first Halbach array of the prior art, of linear shape;

FIG. 2 is a diagrammatic view of a second Halbach array of the prior art, of annular shape;

FIG. 3 shows a process for manufacturing a magnetic body with sinusoidal magnetisation of Halbach type, according to the invention;

FIG. 4A is a diagrammatic view of a magnetic alignment device according to a first embodiment of the invention for implementing the process shown in FIG. 3, wherein the one-directional magnetic flux extends in a first direction;

FIG. 4B is a view identical to that of FIG. 4A, wherein the one-directional magnetic flux extends in a second direction;

FIG. 5A is a diagrammatic view of a magnetic alignment device according to a second embodiment of the invention for implementing the manufacturing process shown in FIG. 3, wherein the magnetic flux extends in a first direction;

FIG. 5B is a view identical to that of FIG. 5A, wherein the magnetic flux extends in a second direction.

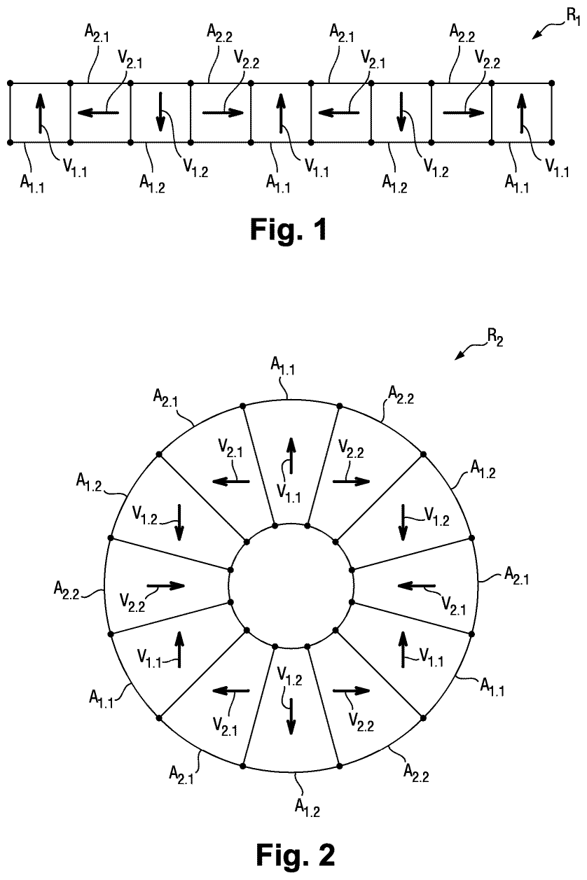

### DETAILED DESCRIPTION OF THE INVENTION

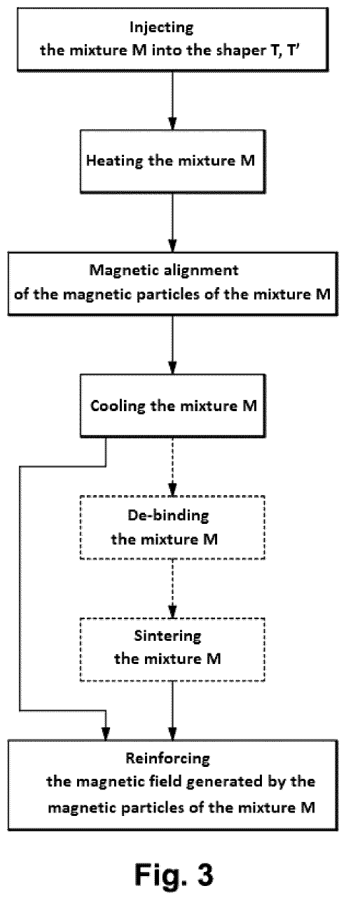

With reference to FIG. 3, a process for manufacturing a magnetic body C with sinusoidal magnetisation of Halbach type is described below.

A tube T of rectangular section is previously filled with a mixture M, also known as a “feedstock”, comprising magnetic particles and a viscous polymer-based binder. The tube T is made of non-magnetic material, for example, stainless steel (for example, 316L, 304L steel or an austenitic equivalent) or titanium, and forms an X-axis linear shaper. The magnetic particles are in the form of a powder of permanent magnets, for example: a powder of particles made of a samarium and cobalt alloy (SmCo); a powder of particles made of a neodymium, iron and boron alloy (NdFeB); a powder of particles made of ferrite, etc. The volumetric charge rate of the magnetic particles in the mixture M is, in this case, substantially equal to 60%. The binder is composed of thermoplastics, thinners and wetting agents. The mixture M is inserted under pressure into the tube T via an injection press (not shown), that makes it possible to forcibly introduce said mixture M into a mould wherein the tube T has been previously received.

Once filled with the mixture M, the tube T is ready to be inserted into a magnetic alignment device 1 making it possible to orientate the magnetic particles of the mixture M according to a magnetisation vector which extends in a plane P containing the longitudinal axis X of the tube T, and whose direction varies continuously as a function of the distance separating the magnetic particles from one end of the tube T.

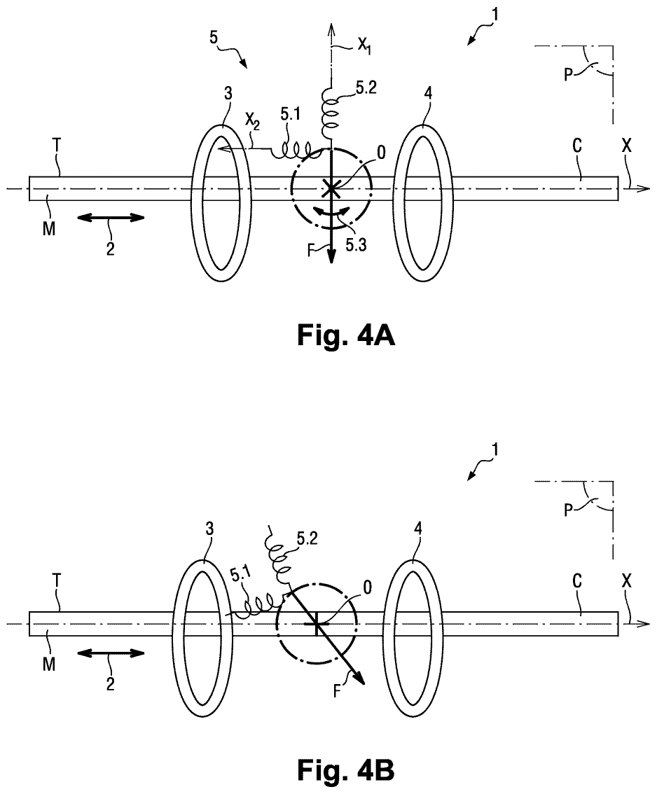

With reference to FIGS. 4A-4B, the magnetic alignment device 1 comprises a motorised platform 2, a heating element 3, a cooling element 4, and a one-directional magnetic flux generator 5.

The motorised platform 2 is movably mounted on a frame and arranged to translate the tube T along its longitudinal axis X. The translation speed of the tube T is controllable. The motorised platform 2 comprises, for example, a carriage that is translated along a rail by a motor and that is provided with means for clamping one end of the tube T.

The heating element 3 is attached relative to the frame and is arranged to locally increase the temperature of the mixture M contained in the tube T to a pre-determined heating temperature. The heating temperature is between the glass transition temperature (Tg) of the binder below which said binder is said to be glassy and behaves like an elastic solid body, and the Curie temperature of the magnetic particles of the powder above which said magnetic particles lose their ferromagnetic properties. The heating temperature is chosen so that at this temperature, the binder used is both sufficiently liquid to allow orientation of the magnetic particles via the one-directional magnetic flux generator 5, and sufficiently solid to prevent any movement of the magnetic particles due to the displacement of the tube T via the motorised platform 2. The heating element 3, in this case, comprises a heating collar arranged to extend around a section of the tube T and to pass through the entire tube T progressively as said tube T moves along its axis X via the motorised platform 2. For example, the heating collar is of the resistive type.

The cooling element 4 is attached relative to the frame and is arranged to locally decrease the temperature of the mixture M heated by the heating element 3, to a pre-determined cooling temperature. The cooling temperature is lower than the glass transition temperature (Tg) of the binder and is selected such that at said cooling temperature, the binder used is sufficiently solid or viscous to prevent any of the magnetic particles from moving. The cooling element 4, in this case, comprises a cooling collar arranged to extend around a section of the tube T and to pass through the entire tube T progressively as said tube T moves along its axis X via the motorised platform 2. For example, the cooling collar 4 is a copper ring cooled by circulating water or by spraying a decompression gas.

The one-directional magnetic flux generator 5 is arranged between the heating element 3 and the cooling element 4, and is arranged to locally subject the mixture M heated by the heating element 3 to a one-directional magnetic flux. This magnetic flux F extends in the magnetisation plane P comprising the longitudinal axis X of the tube T and has a direction that varies continuously as a function of the displacement of the tube T via the motorised platform 2 by pivoting about a fixed point O referred to as the magnetic alignment point. This magnetic alignment point O belongs to the longitudinal axis X of the tube T and is, in this case, arranged at a substantially equal distance from the heating element 3 and the cooling element 4. The magnetic flux F has a sufficient intensity to orientate, in the direction of the magnetic flux F, the magnetic particles of the mixture M heated by the heating element 3.

The one-directional magnetic flux generator 5 comprises an electromagnet comprising, in this case, a first electromagnetic coil 5.1 of the axis X₁ and a second electromagnetic coil 5.2 of the axis X₂. The first coil 5.1 and the second coil 5.2 are selectively powered by, respectively, a first electric current and a second electric current. The axes X₁, X₂ of the first and second coils 5.1, 5.2 are perpendicular and extend in the magnetisation plane P.

The electromagnet formed by the first coil 5.1 and the second coil 5.2 is, in this case, carried by a motorised plate 5.3 that is movably mounted on the frame to ensure that the electromagnet rotates in the magnetisation plane P, substantially about the magnetic alignment point O.

The magnetic flux F is obtained from the magnetic fields generated by the first and second coils 5.1, 5.2. The variation in the direction of the magnetic flux F is obtained by rotating the electromagnet via the plate 5.3 (FIG. 4A), and/or by modulating the intensity of the first current and/or of the second electric current passing through the first and second coils 5.1, 5.2 (FIG. 4B).

The tube T containing the mixture M is thus inserted into the magnetic alignment device 1. While the motorised platform 2 causes a translation of the tube T along its longitudinal axis X, each section of said tube T is successively subjected to:
the heating element 3 in order to locally heat the mixture M until it reaches the heating temperature and to thus allow a modification of the orientation of the magnetic particles contained in said mixture M;
the one-directional magnetic flux generator 5 in order to orientate the magnetic particles in a direction that extends in a plane containing the longitudinal axis X of the tube T and that varies continuously as a function of the distance separating the magnetic particles and one end of the tube T; and
the cooling element 4 in order to locally cool the heated mixture M until it reaches the cooling temperature and thus fix the orientation of the magnetic particles bonded by the binder.

Thus, at the output of the magnetic alignment device 1, a tube T is obtained, containing a powder of bonded magnets emitting a magnetic field of sinusoidal shape such as a Halbach array. The variation in the orientation of the magnetic particles in the magnetisation plane P depends on:
the translation speed that the tube T is subjected to via the motorised platform 2;
the speed at which the direction of the magnetic flux F via the plate 5.3 varies; and
the speed at which the direction of the magnetic flux F varies via the relative modulation of the intensities of the first and second currents passing through the first and second coils 5.1, 5.2.

The bonded magnets thus form a magnetic body C of linear shape with sinusoidal magnetisation of Halbach type.

In order to reinforce the magnetic field emitted by the permanent magnets, it is possible to insert the tube T again into the magnetic alignment device 1′ in order to once again subject said permanent magnets to the one-directional magnetic flux F emitted by the one-directional magnetic flux generator 5, but by deactivating the heating element 3 and the cooling element 4.

For the same purpose, it is also possible to increase the relative density of permanent magnets inside the tube T by performing de-binding and then densification by sintering the mixture M. The de-binding, i.e., the removal of the binder present inside the tube T12, may, for example, be performed by placing the tube T12 vertically in a furnace under partial argon gas pressure by previously either screwing a plug to the bottom end of the tube or pinching said bottom end. Such de-binding makes it possible to obtain a relative density of permanent magnets greater than 90%. If a relative density equal to 100% is necessary, the end of the tube T remaining open will in turn be closed and the tube T will be inserted into an HIP (Hot Isostatic Pressing) enclosure to undergo hot isostatic compacting. Once sintering has been performed, a tube T containing a solid magnet emitting a sinusoidal magnetic field of Halbach type is then obtained.

It must be noted that the mixture M must have properties compatible with the implementation of the process for manufacturing the body C, and also the application wherein said body C is used. It must thus have a rheology adapted to injection operations, and also, if necessary, for de-binding and sintering operations (the residual impurity level of the of powder permanent magnets is low, in particular, the residual carbon level): mixtures of polymers composed of polyethylene (PE), stearic acid (AS), polyethylene glycol (PEG), paraffin (PW), and/or polymethyl methacrylate (PMMA), etc., may be used as a binder.

It must also be noted that such a manufacturing process and such a magnetic alignment device 1 make it possible to manufacture a Halbach array having a length ranging from 10 mm to several metres, without modifying said magnetic alignment device 1.

It must also be noted that the tube T may be cut into sections.

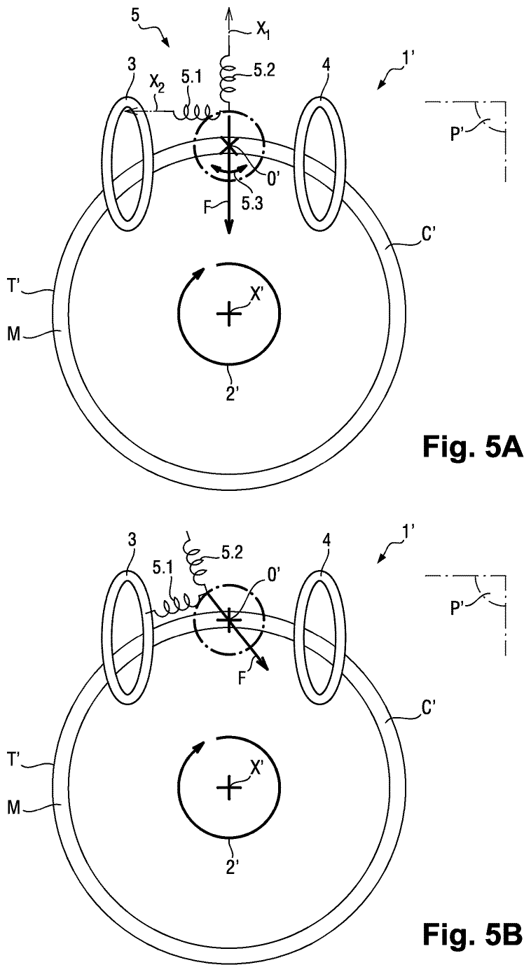

FIGS. 5A-5B show a magnetic alignment device 1′ that is a variant of the magnetic alignment device 1 for manufacturing a magnetic body C′ of annular shape with sinusoidal magnetisation of Halbach type.

A hollow ring T′ of rectangular section is previously filled with the mixture M. The ring T′ is made of a non-magnetic material, for example, stainless steel (for example, 316L, 304L steel or austenitic equivalent) or titanium, and forms an annular shaper of the axis X′. The mixture M is inserted under pressure into the ring T′ via an injection press (not shown) that makes it possible to force the introduction of said mixture M into a mould wherein the ring T′ is previously received.

Once filled with the mixture M, the tube T′ is ready to be inserted into the magnetic alignment device 1′ making it possible to orientate the magnetic particles of the mixture M according to a magnetisation vector that extends in a plane P′ orthogonal to the central axis X′ of the ring T′, and whose direction varies continuously as a function of the angular position of the said magnetic particles about said central axis X′. The plane P′, in this case, contains a generator of the ring T′.

The magnetic alignment device 1′ differs from the magnetic alignment device 1 in that the motorised platform 2 is replaced by a motorised platform 2′ movably mounted on the frame to ensure rotation of the ring T′ about its central axis X′. The rotation speed of the ring T′ is controllable. The motorised platform 2′ comprises, for example, a carriage that is rotated along a rail by a motor and that is provided with means for clamping one or more sections of the ring T′.

The heating element 3 is arranged to locally increase the temperature of the mixture M contained in the ring T′ up to the pre-determined heating temperature.

The cooling element 4 is arranged to locally decrease the temperature of the mixture M heated by the heating element 3, to the pre-determined cooling temperature.

The magnetic flux F delivered by the one-directional magnetic flux generator 5 extends in the magnetisation plane P′ orthogonal to the central axis X of the ring T′ and has a direction that varies continuously as a function of the rotation of the ring T′ via the motorised platform 2′ by pivoting about a fixed point O′ referred to as the magnetic alignment point. This magnetic alignment point O′ belongs to the generator of the ring T′ and is arranged at a substantially equal distance from the heating element 3 and the cooling element 4.

The electromagnet of the one-directional magnetic flux generator 5 is carried by the motorised plate 5.3′ that is movably mounted on the frame to ensure that the electromagnet rotates in the magnetisation plane P′, substantially about the magnetic alignment point O′.

The ring T′ containing the mixture M is thus inserted into the magnetic alignment device 1′. While the motorised platform 2′ causes a rotation of the tube T′ about its axis X′, each section of said tube T′ is successively subjected to:
the heating element 3 in order to locally heat the mixture M until it reaches the heating temperature and to thus allow a modification of the orientation of the magnetic particles contained in said mixture M;
the one-directional magnetic flux generator 5 in order to orientate the magnetic particles in a direction that extends in the plane P′ orthogonal to the central axis X′ of the ring T′ and that varies continuously as a function of the angular position of said magnetic particles about said central axis X′;
the cooling element 4 in order to locally cool the heated mixture M until it reaches the cooling temperature and thus fix the orientation of the magnetic particles bonded by the binder.

Thus, at the output of the magnetic alignment device 1′, a ring T′ is obtained, containing a powder of bonded magnets emitting a magnetic field of sinusoidal shape such as a Halbach array. The variation in the orientation of the magnetic particles in the magnetisation plane P′ depends on:
the translation speed that the ring T′ is subjected to via the motorised platform 2′;
the speed at which the direction of the magnetic flux F via the plate 5.3 varies;
the speed at which the direction of the magnetic flux F varies via the relative modulation of the intensities of the first and second currents passing through the first and second coils 5.1, 5.2.

The bonded magnets thus form a ring-shaped magnetic C′ body with sinusoidal magnetisation of Halbach type.

In order to reinforce the magnetic field emitted by the permanent magnets, it is possible to insert the ring T′ again into the magnetic alignment device 1′ in order to once again subject said permanent magnets to the one-directional magnetic flux F emitted by the one-directional magnetic flux generator 5, but by deactivating the heating element 3 and the cooling element 4.

For the same purpose, it is also possible to increase the relative density of permanent magnets inside the ring T′ by performing de-binding and then densification by sintering the mixture M.

It must be noted that the mixture M must have properties compatible with the implementation of the process for manufacturing the body C′, and also the application wherein said body C′ is used. It must therefore have a rheology adapted to the injection operations, and also, if necessary, to the de-binding and sintering operations.

It must also be noted that such a manufacturing process and such a magnetic alignment device 1′ make it possible to manufacture a Halbach array having a diameter ranging substantially from several centimetres to several tens of centimetres, without modifying said magnetic alignment device 1′.

Naturally, the invention is not limited to the embodiments described, but includes any variant within the scope of the invention such as defined by the claims.

Although the one-directional flux generator 5, in this case, comprises two coils 5.1, 5.2, it may comprise only one. The orientation of the one-directional magnetic flux F in the magnetisation plane P, P′ then depends solely on the angular position of the plate 5.3.

To perform the de-binding and sintering operations, it is possible to envisage removing the tube T, T′ and/or installing a new tube.

The dimensions and shape of the magnets T, T′ may be different from those described.

Although the binder, in this case, comprises a mixture of polymers composed of thermoplastics, thinners and wetting agents, it may also comprise a mixture composed of a single polymer.

The final viscosity of the M mixture will be adapted as a function of the binder, the size and geometry of the magnetic particles, the geometry of the shaper, etc.

1. A process for manufacturing a manufacturing a magnetic body with sinusoidal magnetisation of Halbach type, comprising the following steps:
introducing into a shaper, of linear or annular shape, a mixture comprising magnetic particles and at least one binder;
heating the mixture to a heating temperature between the glass-transition temperature of the binder and the Curie temperature of the magnetic particles;
when the shaper is of linear shape, aligning the magnetic particles so as to assign them a magnetisation vector that extends in a magnetisation plane containing a longitudinal axis of the shaper and whose direction varies continuously as a function of the distance separating the magnetic particles and one end of the shaper;
when the shaper is of annular shape, aligning the magnetic particles so as to assign them a magnetisation vector that extends in a magnetisation plane orthogonal to a central axis of the shaper and whose direction varies continuously as a function of the angular position of the magnetic particles about the central axis;
cooling the mixture down to a cooling temperature below the glass-transition temperature of the binder.

2. The process according to claim 1, further comprising de-binding and sintering the mixture.

3. The process according to claim 1, further comprising reinforcing the magnetic field emitted by the magnetic particles.

4. A magnetic alignment device for implementing the method according to claim 1, comprising:
a motorised platform arranged to ensure, when the shaper is of linear shape, a translation of said shaper along its longitudinal axis, or, when the shaper is of annular shape, a rotation of said shaper about its central axis;
a heating element attached relative to the motorised platform and arranged to locally increase the temperature of the mixture contained in the shaper up to the heating temperature;
a cooling element attached relative to the motorised platform and arranged to locally decrease the temperature of the mixture contained in the shaper up to the cooling temperature;
a one-directional flux generator arranged between the heating element and the cooling element, and arranged to locally subject the magnetic particles to a one-directional magnetic flux that extends in the magnetisation plane and whose direction varies continuously as a function of the displacement or rotation of the shaper.

5. The magnetic alignment device according to claim 4, wherein the heating element comprises a heating collar arranged to extend around a portion of the shaper.

6. The magnetic alignment device according to claim 5, wherein the heating collar is of the resistive type.

7. The magnetic alignment device according to claim 4, wherein the cooling element comprises a cooling collar arranged to extend around a portion of the shaper.

8. The magnetic alignment device according to claim 7, wherein the cooling collar is a copper ring cooled by circulating water or by spraying a decompression gas.

9. The magnetic alignment device according to claim 4, wherein the one-directional magnetic flux generator comprises at least one electromagnetic coil that is selectively powered by an electric current to generate a magnetic field from which the one-directional magnetic flux is obtained.

10. The magnetic alignment device according to claim 9, wherein the one-directional magnetic flux generator comprises a first electromagnetic coil and a second electromagnetic coil arranged perpendicularly to each other, the first coil and the second coil being respectively powered by a first electric current and a second electric current arranged to generate a first magnetic field and a second magnetic field from which the one-directional magnetic flux is obtained, and to vary the direction of said one-directional magnetic flux in the magnetisation plane.
